(19) United States
(12) Patent Application Publication
(10) Pub. No.: US 2016/0070478 A1
(43) Pub. Date: Mar. 10, 2016

(54) STORAGE CONTROL DEVICE AND STORAGE CONTROL METHOD

(71) Applicant: FUJITSU LIMITED, Kawasaki-shi (JP)

(72) Inventors: Shuji HARA, Nagano (JP); Shigeru TSUKADA, lnagi (JP); Tomo FUKUI, Machida (JP)

(73) Assignee: Fujitsu Limited, Kawasaki-shi (JP)

(21) Appl. No.: 14/749,936

(22) Filed: Jun. 25, 2015

(30) Foreign Application Priority Data
Sep. 10, 2014 (JP) 2014-184051

(51) Int. Cl. G06F 3/06

(52) U.S. Cl. CPC G06F 3/0607; G06F 3/0689; G06F 3/0619; G06F 3/0665; G06F 3/0635

(57) ABSTRACT

A storage control device includes a processor to extract a first path to be subjected to load distribution of I/O access from among the first paths connecting virtual disks to a higher-level device in response to scale-out of a storage system based on performance information for the first paths, set a new first path that connects the higher-level device to a new virtual disk having the same space as a virtual disk to which the extracted first path is connected, set a new second path that connects the new virtual disk to an added memory device, use the extracted first path to read existing data stored in the virtual disk connected to the extracted first path, and use the new first path to write and read new data to be written to the new virtual disk as differential data to the existing data.

### CROSS-REFERENCE TO RELATED APPLICATION

This application is based upon and claims the benefit of priority of the prior Japanese Patent Application No. 2014-184051, filed on Sep. 10, 2014, the entire contents of which are incorporated herein by reference.

### FIELD

The embodiment discussed herein is related to a storage control device and a storage control method.

### BACKGROUND

In related art, there is a storage system in which state monitoring, configuration changes, and maintenance work may be performed through a graphical user interface (GUI) with a Web browser or the like of a management device. In addition, a storage system may be scaled out when a storage space becomes short or input/output (I/O) access performance becomes low.

As a related art technique, for example, there is a technique in which when a migration instruction is issued from a management terminal, an external volume related to a selected logical volume is transferred from a first virtualization storage apparatus to a newly introduced second virtualization storage apparatus. Moreover, there is a technique in which processing configuration information indicating a processing procedure is generated from a request from a client terminal, data to be processed is acquired based on the processing configuration information, and the data to be processed is distributed to each node so that processing loads on the nodes are balanced.

Japanese Laid-open Patent Publication No. 2006-330895 and Japanese Laid-open Patent Publication No. 2013-025425 are examples of related art.

However, in related art techniques, even when a storage system is scaled out, I/O access performance may not be increased as expected by a user. For example, during scale-out, if data is migrated to an expansion shelf to distribute an access load on a path, an amount of migrated data may become large and a system load may become high, influencing I/O accesses.

### SUMMARY

According to an aspect of the invention, a storage control device includes a memory that stores performance information for first paths that connect virtual disks in a storage system to a higher-level device and performance information for second paths that connect memory devices in the storage system to the virtual disks, and a processor configured to extract a first path to be subjected to load distribution of I/O access from among the first paths in response to scale-out of the storage system by referring to the performance information for the first paths, set a new first path that connects a new virtual disk to the higher-level device, the new virtual disk having the same space as a virtual disk to which the first path to be subjected to load distribution is connected, set a new second path that connects the new virtual disk to an added memory device, use the first path to be subjected to load distribution to read existing data stored in the virtual disk that is connected to the first path to be subjected to load distribution, and use the new first path to write and read new data to be written to the new virtual disk as differential data to the existing data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a system configuration example of a storage system;

FIG. 2 illustrates an example of a control method according to an embodiment;

FIG. 3 is a block diagram illustrating a hardware configuration example of a storage control device;

FIG. 4 illustrates a specific example of path management information;

FIGS. 5A and 5B illustrate a data structure example of performance information;

FIG. 6 illustrates a specific example of an iSCSI target definition file;

FIG. 7 is a block diagram illustrating a functional configuration example of the storage control device;

FIGS. 8A and 8B are a flowchart illustrating an example of a first path generation processing procedure by the storage control device;

FIG. 9 is a flowchart illustrating an example of a second path generation processing procedure by the storage control device;

FIG. 10 is a flowchart illustrating an example of a specific processing procedure of processing for deciding a path to be subjected to load distribution;

FIG. 11 is a flowchart illustrating an example of a specific processing procedure of throughput determination processing;

FIG. 12 is a flowchart illustrating an example of a specific processing procedure of IOPS determination processing;

FIG. 13 is a flowchart illustrating an example of a specific processing procedure of an HDD space determination processing;

FIG. 14 is a flowchart illustrating an example of a first path control processing procedure by the storage control device; and

FIG. 15 is a flowchart illustrating an example of a second path control processing procedure by the storage control device.

### DESCRIPTION OF EMBODIMENT

A storage control device and a storage control method according to the present embodiment will now be described with reference to the drawings.

### Embodiment

A system configuration example of a storage system according to the embodiment will first be described.

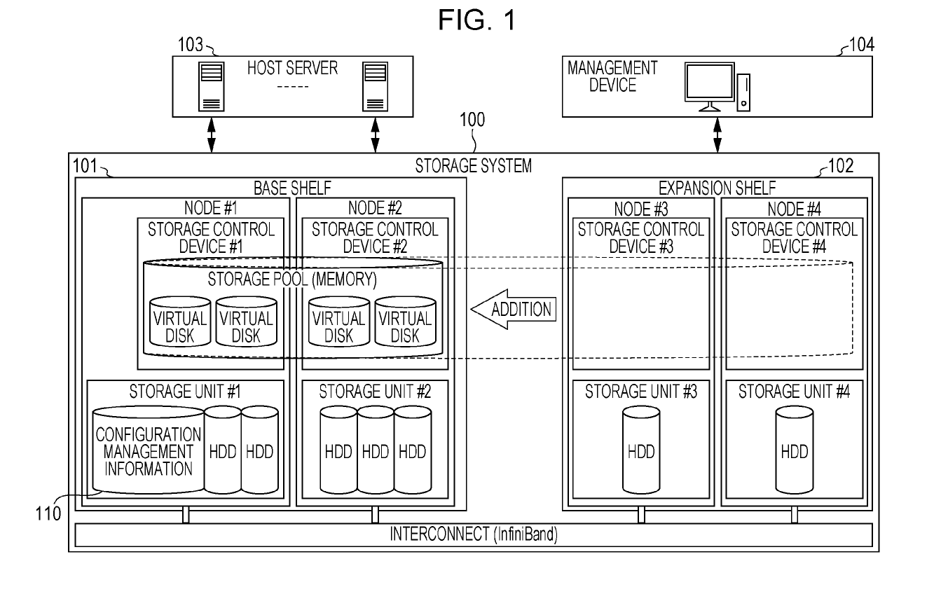

FIG. 1 illustrates a system configuration example of a storage system 100. In FIG. 1, the storage system 100 includes a base shelf 101 and an expansion shelf 102. The base shelf 101 includes a node #1 and a node #2, which may operate as storage apparatuses independently. The node #1 has a storage control device #1 and a storage unit #1, and the node #2 has a storage control device #2 and a storage unit #2.

The storage control devices #1 and #2 are computers that control the storage units #1 and #2 under the storage control devices #1 and #2. The storage units #1 and #2 each include one or more memory devices (storages). The memory device is, for example, a hard disk drive (HDD), a magnetic tape, an optical disk, a solid state drive (SSD), or the like. The following description is given with an “HDD” as an example of the memory device in the storage unit.

The storage control device #1 serves as a master controller, manages other storage control devices (for example, storage control devices #2 to #4), and controls the entire system. For example, the storage control device #1 has a function of making storage units #3 and #4 available to expand the storage space of the entire storage system 100 when the expansion shelf 102 is connected to the base shelf 101.

When the storage units #3 and #4 are connected and made accessible, the storage control devices #1 and #2 manage also HDDs in the storage units #3 and #4 as storages under the storage control devices #1 and #2. Then, the storage control devices #1 and #2 accept I/O accesses to the HDDs in the storage units #1 to #4 from a higher-level device (for example, a host server 103).

The expansion shelf 102 includes nodes #3 and #4. The nodes #3 and #4 are “members” for expansion and, for example, built into the storage system 100 to function as storage apparatuses. The nodes are connected via, for example, an interconnect (InfiniBand). The node #3 has a storage control device #3 and a storage unit #3, and the node #4 has a storage control device #4 and a storage unit #4.

The storage control devices #3 and #4 are computers that control the storage units under the storage control devices #3 and #4. When the expansion shelf 102 is connected to the base shelf 101, the storage control devices #3 and #4 manage the HDDs in the storage units #1 to #4 as storages under the storage control devices #3 and #4. Then, the storage control devices #3 and #4 accept I/O accesses to the HDDs in the storage units #1 to #4 from the higher-level device.

The host server 103 is a computer that issues I/O accesses (access requests) to the HDDs in the storage units #1 to #4, and, for example, a business server which has a business application installed. The host server 103 is connected to the storage control devices #1 to #4 via, for example, an I/O LAN.

As an I/O access protocol, for example, a protocol of the Internet Small Computer System Interface (iSCSI), the Network File System (NFS), or the Common Internet File System (CIFS) may be used. The following description is given with the “iSCSI” as an example of the I/O access protocol.

As access paths from the host server 103 to the HDDs, there are a path connecting the host server 103 and a virtual disk (referred to below as a “first path”) and a path connecting a virtual disk and an HDD (referred to below as a “second path”). The virtual disk is a virtual volume provided by the storage system 100, and, for example, created on any of the storage control devices #1 to #4.

A management device 104 is a computer used by a manager of the storage system 100 and has a management GUI for performing state monitoring, configuration changes, and maintenance work for the storage system 100. The management device 104 is connected to the storage control devices #1 to #4 via, for example, a management LAN.

An example of a work procedure during scale-out (expansion) will now be described with an example in which the expansion shelf 102 is added to the base shelf 101 in the storage system 100. The scale-out of the storage system 100 is an attempt to increase a storage space and I/O access performance by adding an expansion shelf including one or more expansion sets (nodes), each set having a storage control device and a storage unit. It is assumed that the expansion is performed with one shelf at a time.

First, a customer engineer (CE) connects the nodes #3 and #4 of the expansion shelf 102 and the nodes #1 and #2 of the base shelf 101 and turns on the power to the expansion shelf 102. As a result, when the expansion shelf 102 is detected by an InfiniBand driver, a detection result is displayed on the GUI of the management device 104.

Next, a user of the management device 104 makes an instruction for adding the expansion shelf 102 for, for example, a master controller (for example, the storage control device #1). At this time, the user may determine performance information or a storage space for access paths (first path and second path) via the GUI of the management device 104 and manually makes a specific addition instruction for increasing the storage space and the I/O access performance.

For example, to increase the I/O access performance, there is a method of migrating data to the expansion shelf 102 and distributing access loads on the first path and the second path. However, if an amount of the data to be migrated from the base shelf 101 to the expansion shelf 102 is large, a system load becomes high, influencing the I/O accesses.

Although the user expects an immediate result of an increase in the I/O access performance and the storage space by the expansion, operation is stopped, that is, the I/O accesses are stopped, during the expansion processing. Therefore, when data is migrated during the expansion, the operation is influenced if the data migration time is long.

Depending on a learning level of the user, load distribution performed during the expansion may be insufficient and therefore an effect may not be produced as expected. For example, to decide an access path to be subjected to load distribution, the user has to understand the system specifications and have knowledge that allows the user to determine a bottleneck path from performance information. Therefore, for example, if a user at a low learning level carries out the work, there may be a danger that an operation mistake occurs during the work.

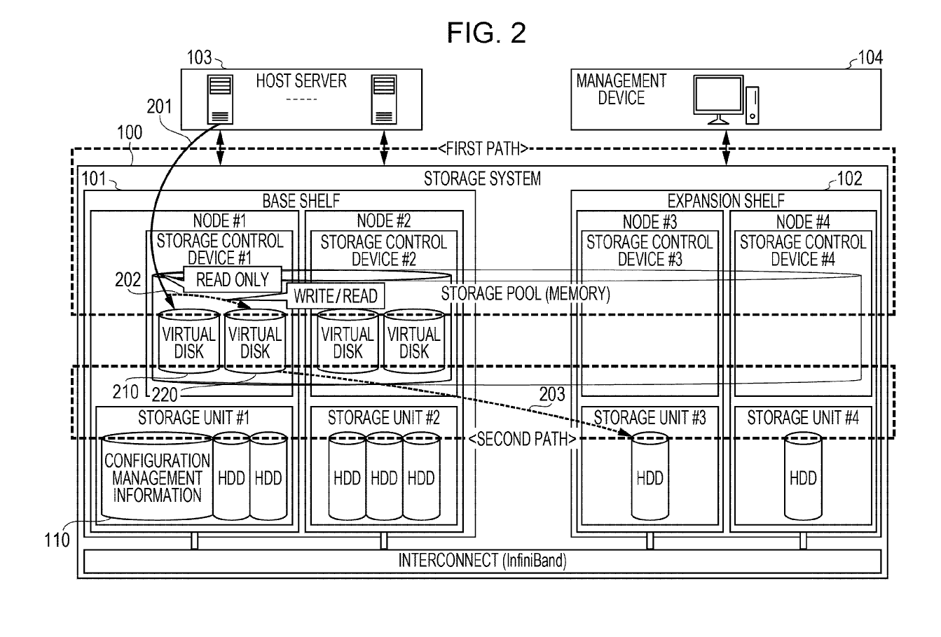

In the embodiment, a control method will be described by which I/O access performance is increased by distributing a load on an access path through access path addition and control, without migrating data, during scale-out of the storage system 100. An example of the control method according to the embodiment will now be described with FIG. 2.

FIG. 2 illustrates an example of the control method according to the embodiment.

(1) In response to scale-out of the storage system 100, the storage control device #1 refers to performance information for first paths and extracts a first path to be subjected to I/O access load distribution. The I/O access is an access request to any of the HDDs in the storage units #1 to #4. As an access request, there is a Read request (read instruction) or a Write request (write instruction).

The performance information for the first paths is information indicating performance of the first path connecting the host server 103 and a virtual disk. The performance information for the first paths includes, for example, response time of the first path. The response time is time from the issue of a processing request to the storage system 100 via the first path to the start of output of a processing result.

The performance information for the first paths is included in, for example, configuration management information 110. The configuration management information 110 is information for managing a configuration of the storage system 100. The configuration management information 110 includes, for example, path management information, performance information for first paths, performance information for second paths, information for managing virtual disks, information for managing segments forming the virtual disks, an active/inactive state or unique information (for example, an IP address) for each node, and the like, which will be described later.

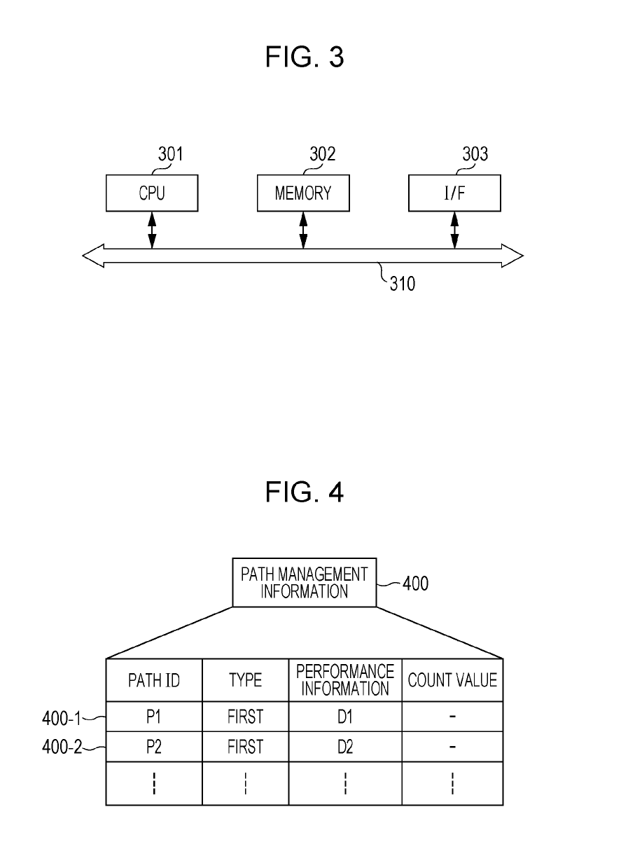

The configuration management information 110 is stored in, for example, in any of the HDDs in the storage unit #1. The storage control device #1 reads and uses the configuration management information 110 from the HDD in the storage unit #1. The read configuration management information 110 is stored in, for example, a memory 302 illustrated in FIG. 3, which will be described later.

Specifically, for example, in response to acceptance of an addition instruction from the management device 104, the storage control device #1 refers to the performance information for the first paths, and extracts, among the first paths, any path which has response time of a value greater than or equal to an average value as a first path to be subjected to load distribution. Accordingly, it is possible to extract a bottleneck path with slow response time as a first path to be subjected to load distribution.

In the example in FIG. 2, a path 201 connecting a certain host server 103 and a virtual disk 210 on the storage control device #1 is extracted as a first path to be subjected to load distribution.

(2) The storage control device #1 creates a new virtual disk that has the same space as the virtual disk to which the extracted first path to be subjected to load distribution is connected. However, if there is a virtual disk that has the same space as the virtual disk to which the first path to be subjected to load distribution is connected, that virtual disk may be used.

In the example in FIG. 2, a new virtual disk 220 that has the same space as the virtual disk 210 to which the first path 201 to be subjected to load distribution is connected is created on the storage control device #1.

(3) The storage control device #1 sets a new first path connecting the new virtual disk and the higher-level device (host server 103). The higher-level device to which the new first path is connected is the same as the higher-level device to which the first path to be subjected to load distribution is connected. The storage control device #1 sets a new second path connecting the new virtual disk and an added HDD. The added HDD is, for example, any of the HDDs in the storage units #3 and #4.

The setting of the new first path is, for example, new definition of a logical connection relationship between a new virtual disk and a higher-level device. The setting of the new second path is, for example, new definition of a logical connection relationship between a new virtual disk and an added HDD.

Specifically, for example, the storage control device #1 creates an iSCSI target definition file for the new first path and sets the iSCSI target definition file in a path driver for the first path. The storage control device #1 creates an iSCSI target definition file for the new second path and sets the iSCSI target definition file in a path driver for the second path.

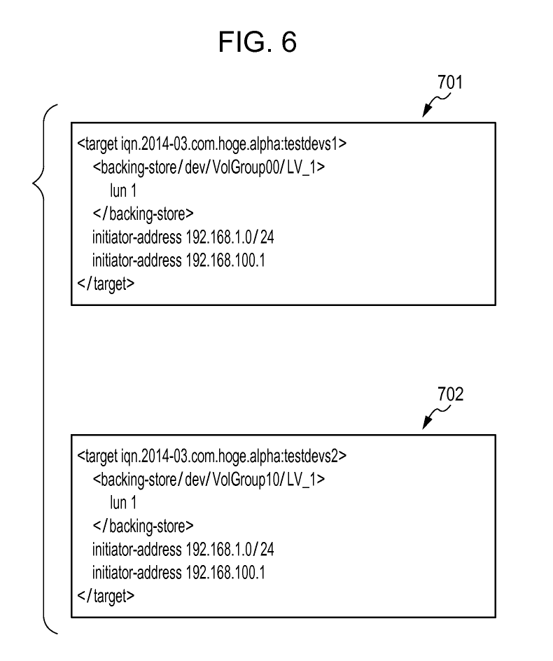

As the iSCSI target definition file (targets.conf), for example, a Linux®-standard file may be used. A specific example of the iSCSI target definition file will be described later with FIG. 6.

In the example in FIG. 2, a first path 202 connecting a certain host server 103 and the new virtual disk 220 is set. A new second path 203 connecting the new virtual disk 220 and an HDD in the storage unit #3 is set.

(4) The storage control device #1 performs control so that the first path to be subjected to load distribution is used to read existing data and the new first path is used to write and read new data. The existing data is existing data stored in the virtual disk to which the first path to be subjected to load distribution is connected. The new data is new data to be written to the new virtual disk as differential data for the existing data.

In the example in FIG. 2, in response to an I/O access from a certain host server 103, the first path 201 to be subjected to load distribution is used to read existing data and the new first path 202 is used to write and read new data.

Thus, in response to scale-out of the storage system 100, the storage control device #1 may refer to performance information D for first paths and extract a first path to be subjected to I/O access load distribution. Accordingly, in response to scale-out of the storage system 100, it is possible to extract a bottleneck first path.

The storage control device #1 may also set a new first path connecting a new virtual disk that has the same space as the virtual disk to which the first path to be subjected to load distribution is connected and the host server 103. The storage control device #1 may also set a new second path connecting the new virtual disk and the added HDD. Accordingly, it is possible to add the new first path for distributing an I/O access load on the first path to be subjected to load distribution.

The storage control device #1 may also perform control so that the first path to be subjected to load distribution is used to read existing data and the new first path is used to write and read new data. Accordingly, it is possible to distribute an I/O access load on the first path to be subjected to load distribution, and increase I/O access performance of the storage system 100 without migrating data between the base shelf and the expansion shelf.

(Hardware Configuration Example of the Storage Control Device #1 or the Like)

A hardware configuration example of the computers of the storage control devices #1 to #4 illustrated in FIG. 1 (referred to herein as the “storage control device #1 or the like”) will next be described.

FIG. 3 is a block diagram illustrating the hardware configuration example of the storage control device #1 or the like. In FIG. 3, the storage control device #1 has a central processing unit (CPU) 301, a memory 302, and an interface (I/F) 303. The components are connected by a bus 310.

The CPU 301 is responsible for controlling the entire storage control device #1 or the like. The memory 302 has, for example, a read only memory (ROM), a random access memory (RAM), a flash ROM, and the like. More specifically, for example, the flash ROM stores a program such as an operating system (OS) or firmware, the ROM stores an application program, and the RAM is used as a work area of the CPU 301. The programs stored in the memory 302 are loaded into the CPU 301 and thereby make the CPU 301 perform coded processing.

The I/F 303 controls input and output of data from other computers. Specifically, for example, the I/F 303 is connected to a network such as a local area network (LAN), a wide area network (WAN), or the Internet through a communication line, and connected to the other computers via the network. Then, the I/F 303 is responsible for interfacing between the network and the inside and controls input and output of data from the other computers.

(Specific Example of the Path Management Information)

A specific example of the path management information included in the configuration management information 110 will next be described.

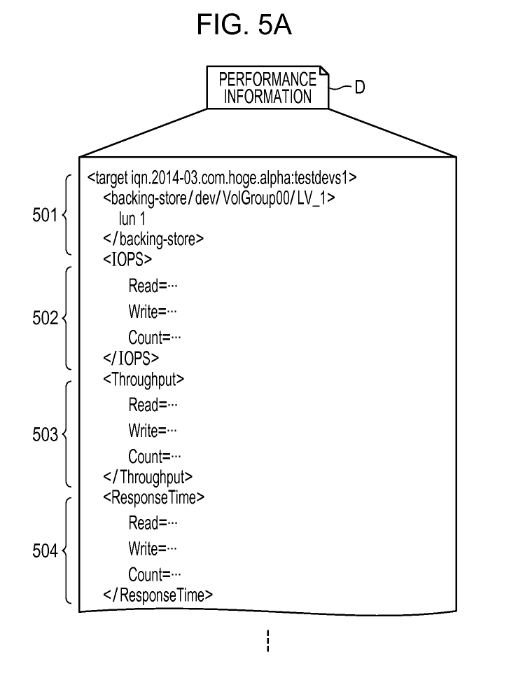

FIG. 4 illustrates the specific example of the path management information. In FIG. 4, path management information 400 has path information for each access path in the storage system 100 (for example, path information 400-1 and 400-2). The path information includes a path ID, a type, performance information, and a count value.

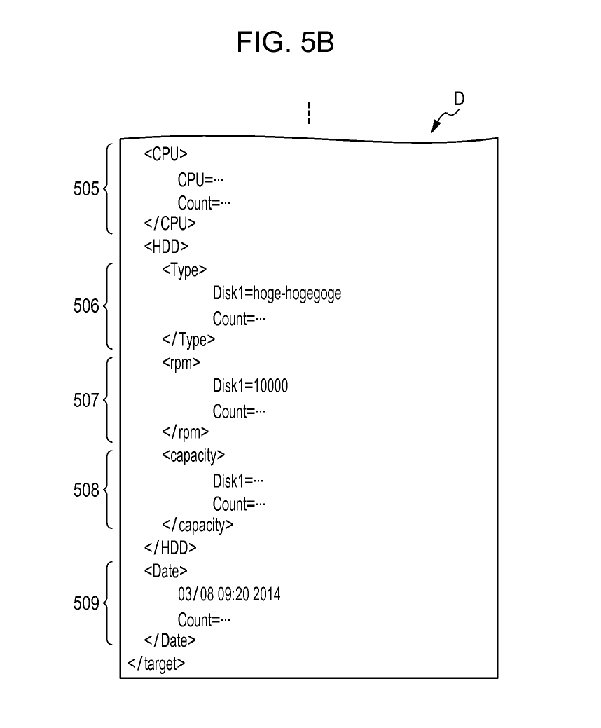

The path ID is an identifier that uniquely identifies an access path. The type indicates whether the access path is a first path or a second path. The performance information is information indicating performance of the access path. A data structure example of the performance information will be described later with FIGS. 5A and 5B. The count value is a value that is used to decide a second path to be subjected to I/O access load distribution.

(Data Structure Example of the Performance Information D)

FIGS. 5A and 5B illustrate a data structure example of the performance information D. In FIGS. 5A and 5B, the performance information D is information indicating performance of an access path. The performance information D includes access destination information 501, IOPS information 502, throughput information 503, response time information 504, CPU information 505, type information 506, rpm information 507, capacity information 508, and date information 509.

The access destination information 501 is information indicating an access destination of an I/O access via an access path. For example, “target . . . testdevs1” is information for an HDD that is an access destination. “LV_{—}1” is an identifier of a virtual disk that is an access destination. “VolGroup00” is an identifier of a group to which the virtual disk that is the access destination belongs. “lun1” is a logical unit number (LUN) to be used as a key by the host server 103 that is an initiator for an access.

The IOPS information 502 is information indicating input output per second (IOPS) of the access path. The IOPS is the number of I/O accesses made via the access path and processed per second by the HDD. Count is an additional value for the IOPS that is used to decide a second path to be subjected to I/O access load distribution, and may be arbitrarily set.

The throughput information 503 indicates throughput of the access path. The throughput is an amount of data input and output per unit time via the access path. Count is an additional value for the throughput that is used to decide a second path to be subjected to I/O access load distribution, and may be arbitrarily set.

The response time information 504 indicates response time of the access path. The response time is time from the issue of a processing request via the access path to the start of output of a processing result. Count is an additional value for the response time that is used to decide a second path to be subjected to I/O access load distribution, and may be arbitrarily set.

The CPU information 505 is information indicating processing performance of a CPU in the same cabinet (same shelf) as an HDD to which the access path is connected. The processing performance of the CPU is represented by, for example, an operating frequency. When a plurality of CPUs are included in the same cabinet, the processing performance may be represented by, for example, an average operating frequency of the plurality of CPUs. Count is an additional value for the CPU processing performance that is used to decide a second path to be subjected to I/O access load distribution, and may be arbitrarily set.

The type information 506 is information indicating a model number of the HDD to which the access path is connected. Count is an additional value for the HDD model number that is used to decide a second path to be subjected to I/O access load distribution, and may be arbitrarily set.

The rpm information 507 is information indicating a rotating speed of the HDD to which the access path is connected. The rotating speed of the HDD is represented by, for example, the number of revolutions per minute. Count is an additional value for the HDD rotating speed that is used to decide a second path to be subjected to I/O access load distribution, and may be arbitrarily set.

The capacity information 508 is information indicating a free space of the HDD to which the access path is connected. The free space of the HDD is represented by, for example, a usage rate (used space/total space) of the HDD. Count is an additional value for the HDD free space that is used to decide a second path to be subjected to I/O access load distribution, and may be arbitrarily set.

The date information 509 indicates the last date and time at which an I/O access was made via the access path. Count is an additional value for the last access date and time that is used to decide a second path to be subjected to I/O access load distribution, and may be arbitrarily set. The performance information D for the first paths is measured by, for example, the path driver for the first path, and the performance information D for the second paths is measured by, for example, the path driver for the second path.

(Specific Example of the iSCSI Target Definition File)

FIG. 6 illustrates a specific example of the iSCSI target definition file. In FIG. 6, an iSCSI target definition file 701 is information for an existing access path. An iSCSI target definition file 702 is information for a new access path. In each of the iSCSI target definition files 701 and 702, information for a target that is an access destination (virtual disk or HDD) and information for an initiator that is an access source (host server 103).

Specifically, the iSCSI target definition files 701 and 702 are examples in which LV_{—}1 (virtual disk or HDD) is defined in a target “iqn.2014-03.com.hoge.alpha:testdevs” and accesses from initiators (IP addresses) “192.168.1.0/24” and “192.168.100.1” are permitted.

(Functional Configuration Example of the Storage Control Device #1 or the Like)

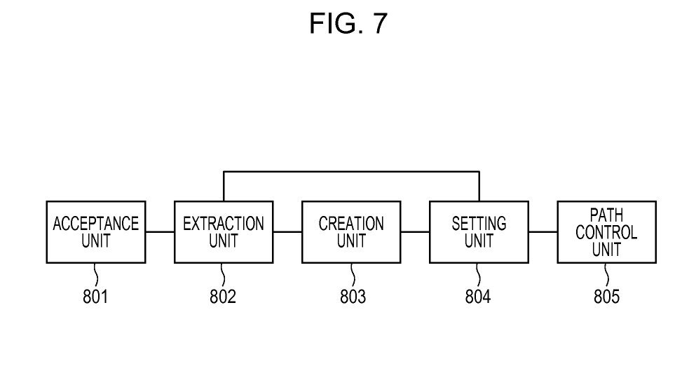

FIG. 7 is a block diagram illustrating a functional configuration example of the storage control device #1 or the like. In FIG. 7, the storage control device #1 or the like is configured to include an acceptance unit 801, an extraction unit 802, a creation unit 803, a setting unit 804, and a path controller 805. The acceptance unit 801 to the path controller 805 are functions that serve as a controller; specifically, for example, the functions are implemented by making the CPU 301 execute a program stored in a memory device such as the memory 302 illustrated in FIG. 3 or by the I/F 303. A result of processing by each function unit is stored in, for example, the memory device such as the memory 302.

<During Scale-Out of the Storage System 100>

The acceptance unit 801 accepts an addition instruction. The addition instruction is used to instruct the storage system 100 to manage an added HDD in a storage unit as a storage under the storage system 100. Specifically, for example, the acceptance unit 801 accepts an addition instruction from the management device 104. The acceptance unit 801 may also accept an addition instruction from a storage control device that serves as a master controller (for example, the storage control device #1).

In response to acceptance of the addition instruction, the extraction unit 802 refers to the performance information D for the first paths and extracts a first path to be subjected to I/O access load distribution. During scale-out (expansion), the user expects an early increase in performance immediately after expansion. Therefore, during scale-out (expansion), a first path that has a narrower band than a second path (for example, 1 [Gbps] or 10 [Gbps]) and is likely to be a bottleneck is set as a path to be subjected to load distribution.

Specifically, for example, the extraction unit 802 first acquires a space of an added HDD (an HDD in a storage unit of an expansion shelf) through a driver of the HDD and adds the space to an existing storage pool. Then, the extraction unit 802 refers to the path management information 400 illustrated in FIG. 4 (see FIG. 4) and acquires the performance information D in which the type is “FIRST”.

Next, the extraction unit 802 refers to the acquired performance information D and identifies response time of first paths in the storage system 100. Then, the extraction unit 802 extracts, among the first paths in the storage system 100, any path which has response time of a value greater than or equal to an average value as a first path to be subjected to load distribution.

More specifically, for example, the extraction unit 802 may extract, among the first paths in the storage system 100, a path which has the largest response time value as a first path to be subjected to load distribution. It is possible to identify the response time of the first path from, for example, the performance information D for the first paths. The response time is, for example, response time during at least a read or a write.

However, the first paths in the storage system 100 may include, for example, a path for which an access frequency has become low and which is no longer used currently. Therefore, the extraction unit 802 may exclude, from paths to be extracted, a first path for which an I/O access has not been made continuously for a fixed time period T or longer, based on, for example, the last access date and time of the first path.

The fixed time period T may be arbitrarily set, and is set as, for example, a time period of about one month. It is possible to identify the last access date and time of the first path from the performance information D for the first paths. Moreover, the extraction unit 802 may measure first path access frequencies in the last fixed time period T and exclude, from paths to be extracted, a first path for which an access frequency is smaller than or equal to a threshold.

The creation unit 803 creates a new virtual disk that has the same space as the virtual disk to which the first path to be subjected to load distribution is connected. It is possible to identify the virtual disk to which the first path is connected from, for example, the performance information D for the first paths. It is also possible to identify the space of the virtual disk to which the first path is connected from the configuration management information 110 of the storage system 100.

In the following description, the virtual disk to which the first path to be subjected to load distribution is connected may be denoted as an “existing virtual disk VD_{—}1” and the new virtual disk that has the same space as the existing virtual disk VD_{—}1 may be denoted as a “new virtual disk VD_{new}”.

The existing virtual disk VD_{—}1 and the new virtual disk VD_{new} are viewed as the same volume from the host server 103 to which the first path to be subjected to load distribution is connected. That is, as an identifier that is used by the host server 103 for identification, the same identifier (for example, a LUN) as the existing virtual disk VD_{—}1 is given to the new virtual disk VD_{new}.

The setting unit 804 sets a new first path connecting the new virtual disk VD_{new} and the host server 103. The host server 103 to which the new first path is connected is the same as the host server 103 to which the first path to be subjected to load distribution is connected. It is possible to identify the host server 103 from, for example, an iSCSI target definition file for the first path to be subjected to load distribution (for example, the iSCSI target definition file 701 illustrated in FIG. 6).

Specifically, for example, the setting unit 804 creates an iSCSI target definition file for the new first path connecting the new virtual disk VD_{new} and the host server 103. Then, the setting unit 804 sets the created iSCSI target definition file for the new first path in the path driver for the first path.

The setting unit 804 also sets a new second path connecting the new virtual disk VD_{new} and the added HDD. The HDD to which connection is established is any of the HDDs in the storage unit of the expansion shelf. It is possible to identify the HDD from, for example, the configuration management information 110.

Specifically, for example, the setting unit 804 creates an iSCSI target definition file for the new second path connecting the new virtual disk VD_{new} and the added HDD. Then, the setting unit 804 sets the created iSCSI target definition file for the new second path in the path driver for the second path.

The path controller 805 performs control so that the first path to be subjected to load distribution is used to read existing data and the new first path is used to write and read new data. The existing data is existing data stored in the existing virtual disk VD_{—}1. The new data is new data to be written to the new virtual disk VD_{new} as differential data for the existing data.

Specifically, for example, the path controller 805 refers to the iSCSI target definition file for the first path and performs path control during an I/O access. More specifically, for example, the path controller 805 first refers to iSCSI frame information and determines whether to perform access path allocation.

The iSCSI frame information is included in an access request from the host server 103, and includes access source information and access destination information. The access source information is, for example, unique information such as an IP address of the host server 103 that is an access source. The access destination information is, for example, a LUN, logical block addressing (LBA), or the like that indicates an access destination.

For example, when there are a plurality of iSCSI target definition files for the first paths in which the same access source (initiator) and access destination (target) as the iSCSI frame information are defined, the path controller 805 determines to perform access path allocation. In this case, the path controller 805 performs access path allocation depending on an access request type.

For example, when an access request is a Write request, the path controller 805 refers to the iSCSI target definition file for the new first path and writes new data in the new virtual disk VD_{new}. At this time, the path controller 805 manages a write position (data block) of the new data by using a differential bitmap.

On the other hand, when an access request is a Read request, the path controller 805 refers to the differential bitmap and determines whether new data is read. If new data is read, the path controller 805 refers to the iSCSI target definition file for the new first path and reads the relevant new data from the new virtual disk VD_{new}. If new data is not read, the path controller 805 refers to the iSCSI target definition file for the existing first path and reads the relevant existing data from the existing virtual disk VD_{—}1.

<During Operation of the Storage System 100>

The extraction unit 802 refers to the performance information D for the second paths and extracts a second path to be subjected to I/O access load distribution. For example, during operation of the storage system 100, a second path to be subjected to load distribution is extracted periodically at a date and time specified in advance by the manager (for example, 0 a.m. every day, 0 a.m. every Monday, or the like).

After operation of the storage system 100 is started, there are path-to-path variations in performance of second paths on a back-end side. Therefore, during operation of the storage system 100, a second path that has a wider band than a first path and is not likely to be a bottleneck but is likely to cause path-to-path variations is set as a path to be subjected to load distribution.

As a second path performance indicator, there is, for example, throughput of a second path. It is considered that the higher the throughput of a second path, the higher the load on the second path. Thus, the extraction unit 802 may refer to the performance information D for the second paths and extract, among the second paths in the storage system 100, any path which has throughput of a value greater than or equal to an average value as a second path to be subjected to load distribution. The throughput is, for example, throughput during at least a read or a write. It is possible to identify the throughput of the second path from, for example, the performance information D for second paths.

Further, as a second path performance indicator, there is, for example, IOPS of a second path. It is considered that the higher the IOPS of a second path, the higher the load on the second path. Thus, the extraction unit 802 may refer to the performance information D for the second paths and extract, among the second paths in the storage system 100, any path which has IOPS of a value greater than or equal to an average value as a second path to be subjected to load distribution. The IOPS is, for example, IOPS during at least a read or a write. It is possible to identify the IOPS of the second path from, for example, the performance information D for the second paths.

However, the second paths in the storage system 100 may include, for example, a path for which an access frequency has become low and which is no longer used currently. Therefore, the extraction unit 802 may exclude, from paths to be extracted, a second path for which an I/O access has not been made continuously for the fixed time period T or longer, based on, for example, the last access date and time of the second path. It is possible to identify the last access date and time of the second path from the performance information D for the second paths.

Further, as a second path performance indicator, there is, for example, processing performance of a CPU in the same cabinet (same shelf) as an HDD to which the second path is connected. It is considered that the higher the processing performance of the CPU, the higher the performance of the second path. Thus, the extraction unit 802 first identifies any of the HDDs in the storage system 100 based on free spaces of the HDDs in the storage system 100. The identified HDD is an HDD to which the second path is connected, which will be described later.

More specifically, for example, the extraction unit 802 may identify, among the HDDs in the storage system 100, an HDD which has the largest free space value. It is possible to identify the free space of the HDD from, for example, the configuration management information 110. In the following description, the HDD to which the second path is connected may be denoted as an “existing HDD” and the HDD to which the new second path is connected may be denoted as a “new HDD”.

Then, the extraction unit 802 may extract a second path to be subjected to load distribution, based on, for example, the processing performance of the CPU in the same cabinet as the existing HDD for each second path and the processing performance of the CPU in the same cabinet as the new HDD. It is possible to identify the processing performance of the CPU from, for example, the configuration management information 110.

Further, as a second path performance indicator, there is, for example, performance of an HDD to which connection is established. It is considered that the higher the performance of the HDD to which connection is established, the higher the performance of the second path. In addition, it is likely that the newer the model number (or date of manufacture) of the HDD, the lower the frequency of occurrence of a disk failure and the faster the rotating speed.

Thus, the extraction unit 802 may extract a second path to be subjected to load distribution, based on, for example, the model number of the existing HDD for each second path and the model number of the new HDD. It is possible to identify the model number of the HDD from, for example, the configuration management information 110.

Moreover, the extraction unit 802 may extract a second path to be subjected to load distribution, based on, for example, the rotating speed of the existing HDD for each second path and the rotating speed of the new HDD. It is possible to identify the rotating speed of the HDD from, for example, the configuration management information 110.

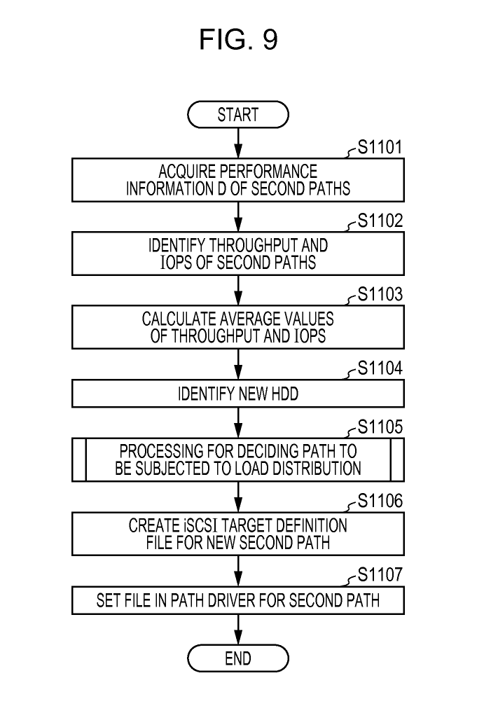

In addition, the extraction unit 802 may extract a second path to be subjected to load distribution, based on the free space of the existing HDD for each second path. It is possible to identify the free space of the HDD from, for example, the configuration management information 110. A specific processing procedure of extraction of a second path to be subjected to load distribution will be described later with flowcharts in FIGS. 10 to 13.

The setting unit 804 sets a new second path connecting the virtual disk to which the second path to be subjected to load distribution is connected and the new HDD. In the following description, the virtual disk to which the second path to be subjected to load distribution is connected may be denoted as an “existing virtual disk VD_{—}2”.

Specifically, for example, the setting unit 804 creates an iSCSI target definition file for the new second path connecting the existing virtual disk VD_{—}2 and the new HDD. Then, the setting unit 804 sets the created iSCSI target definition file for the new second path in the path driver for the second path.

The path controller 805 performs control so that the second path to be subjected to load distribution is used to read existing data and the new second path is used to write and read new data. The existing data is existing data stored in the existing HDD for the second path to be subjected to load distribution. The new data is new data to be written to the new HDD as differential data for the existing data.

Specifically, for example, the path controller 805 refers to the iSCSI target definition file for the second path and performs path control during an I/O access. More specifically, for example, the path controller 805 first refers to iSCSI frame information and determines whether to perform access path allocation.

For example, when there are a plurality of iSCSI target definition files for the second paths in which the same access source (initiator) and access destination (target) as the iSCSI frame information are defined, the path controller 805 determines to perform access path allocation. In this case, the path controller 805 performs access path allocation depending on an access request type.

For example, when an access request is a Write request, the path controller 805 refers to the iSCSI target definition file for the new second path and writes new data in the new HDD. At this time, the path controller 805 manages a write position (data block) of the new data by using the differential bitmap.

On the other hand, when an access request is a Read request, the path controller 805 refers to the differential bitmap and determines whether new data is read. If new data is read, the path controller 805 refers to the iSCSI target definition file for the new second path and reads the relevant new data from the new HDD. If new data is not read, the path controller 805 refers to the iSCSI target definition file for the existing second path and reads the relevant existing data from the existing HDD.

(First Path Generation Processing Procedure by the Storage Control Device #1 or the Like)

A first path generation processing procedure by the storage control device #1 or the like will next be described. First path generation processing is performed in response to scale-out of the storage system 100.

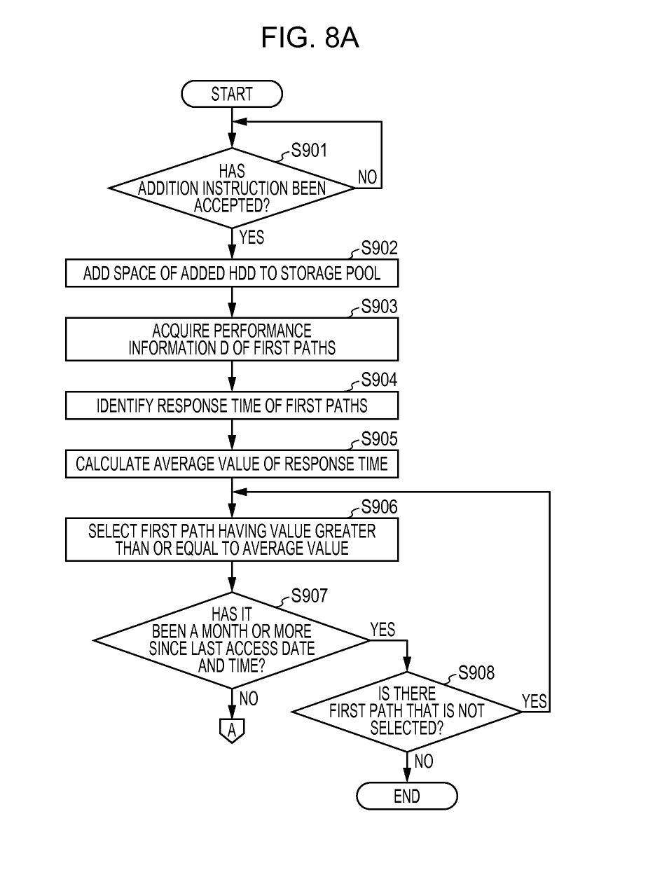

FIGS. 8A and 8B are flowcharts illustrating an example of the first path generation processing procedure by the storage control device #1 or the like. In the flowchart in FIG. 8A, the storage control device #1 or the like first determines whether an addition instruction has been accepted (step S901).

The storage control device #1 or the like waits until an addition instruction is accepted (step S901: NO). When the addition instruction has been accepted (step S901: YES), the storage control device #1 or the like acquires a space of an added HDD through a driver of the HDD and adds the space to an existing storage pool (step S902).

Next, the storage control device #1 or the like refers to the path management information 400 and acquires the performance information D for the first paths (step S903). Then, the storage control device #1 or the like refers to the acquired performance information D for the first paths and identifies the response time of the first paths in the storage system 100 (step S904) and calculates an average value of the response time of the first paths (step S905).

Next, the storage control device #1 or the like selects, among the first paths in the storage system 100, a first path that is not selected and has response time of a value greater than or equal to the average value (step S906). However, a first path to be selected is, for example, a path for which a virtual disk to which connection is established exists on the device for that path.

Then, the storage control device #1 or the like determines whether it has been a month or more since the last access date and time of the selected first path (step S907). If it has not been a month or more since the last access date and time (step S907: NO), the storage control device #1 or the like shifts to step S1001 illustrated in FIG. 8B.

If it has been a month or more since the last access date and time (step S907: YES), the storage control device #1 or the like determines whether there is a first path that is not selected and has response time of a value greater than or equal to the average value (step S908).

If there is a first path that is not selected (step S908: YES), the storage control device #1 or the like returns to step S906. If there is no first path that is not selected (step S908: NO), the storage control device #1 or the like ends a sequence of the processing in this flowchart.

In the flowchart in FIG. 8B, the storage control device #1 or the like first creates a new virtual disk VD_{new} that has the same space as an existing virtual disk VD_{—}1, with the first path selected in step S906 illustrated in FIG. 8A as a first path to be subjected to load distribution (step S1001).

Next, the storage control device #1 or the like creates an iSCSI target definition file for the new first path connecting the new virtual disk VD_{new} and the host server 103 (step S1002). Then, the storage control device #1 or the like sets the created iSCSI target definition file for the new first path in the path driver for the first path (step S1003).

Next, the storage control device #1 or the like creates an iSCSI target definition file for the new second path connecting the new virtual disk VD_{new} and the added HDD (step S1004). Then, the storage control device #1 or the like sets the created iSCSI target definition file for the new second path in the path driver for the second path (step S1005) and ends a sequence of the processing in this flowchart.

Accordingly, in response to scale-out of the storage system 100, it is possible to extract a bottleneck first path and add the new first and second paths for distributing an I/O access load on the first path to be subjected to load distribution. The storage control device #1 or the like may repeat the processing in step S906 and the subsequent steps illustrated in FIG. 8A until the number of first paths to be subjected to load distribution reaches a predetermined number.

(Second Path Generation Processing Procedure by the Storage Control Device #1 or the Like)

A second path generation processing procedure by the storage control device #1 or the like will next be described. Second path generation processing is performed periodically at a date and time specified in advance by the manager (for example, 0 a.m. every day, 0 a.m. every Monday, or the like).

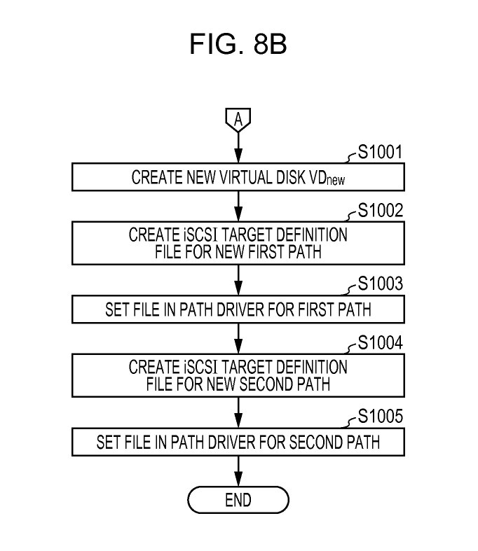

FIG. 9 is a flowchart illustrating an example of the second path generation processing procedure by the storage control device #1 or the like. In the flowchart in FIG. 9, the storage control device #1 or the like first refers to the path management information 400 and acquires the performance information D for the second paths (step S1101). Next, the storage control device #1 or the like refers to the acquired performance information D for the second paths and identifies the throughput and IOPS of the second paths in the storage system 100 (step S1102).

Then, the storage control device #1 or the like calculates average values of the throughput and IOPS of the second paths in the storage system 100 (step S1103). Next, the storage control device #1 or the like identifies a new HDD to which a new second path is connected based on the free spaces of the HDDs in the storage system 100 (step S1104).

Then, the storage control device #1 or the like performs processing for deciding a second path to be subjected to load distribution (step S1105). A specific processing procedure of the processing for deciding a path to be subjected to load distribution will be described later with FIG. 10.

Next, the storage control device #1 or the like creates an iSCSI target definition file for the new second path connecting the existing virtual disk VD_{—}2 and the new HDD (step S1106). Then, the storage control device #1 or the like sets the created iSCSI target definition file for the new second path in the path driver for the second path (step S1107) and ends a sequence of the processing in this flowchart.

Accordingly, during operation of the storage system 100, at a time point specified in advance, it is possible to extract a bottleneck second path and add the new second path for distributing an I/O access load on the second path to be subjected to load distribution.

<Processing Procedure for Deciding a Path to be Subjected to Load Distribution>

The specific processing procedure of processing for deciding a path to be subjected to load distribution in step S1105 illustrated in FIG. 9 will next be described. In the storage system 100, writes to the disks are distributed in each node. Therefore, lower priority is set for the IOPS and higher priority is set for the throughput, which influences the processing performance of the CPU. The free space of the HDD to which connection is established does not influence the performance. Therefore, decision of a second path to be subjected to load distribution will be described while lower priority is set for the free space of the HDD than the priority of the IOPS.

FIG. 10 is a flowchart illustrating an example of the specific processing procedure of processing for deciding a path to be subjected to load distribution. In the flowchart in FIG. 10, the storage control device #1 or the like first selects, among the second paths in the storage system 100, a second path that is not selected and has throughput and IOPS of values greater than or equal to average values (step S1201). However, a second path to be selected is, for example, a path for which a virtual disk to which connection is established exists on the device for that path.

Then, the storage control device #1 or the like determines whether it has been a month or more since the last access date and time of the selected second path (step S1202). If it has been a month or more since the last access date and time (step S1202: YES), the storage control device #1 or the like shifts to step S1206.

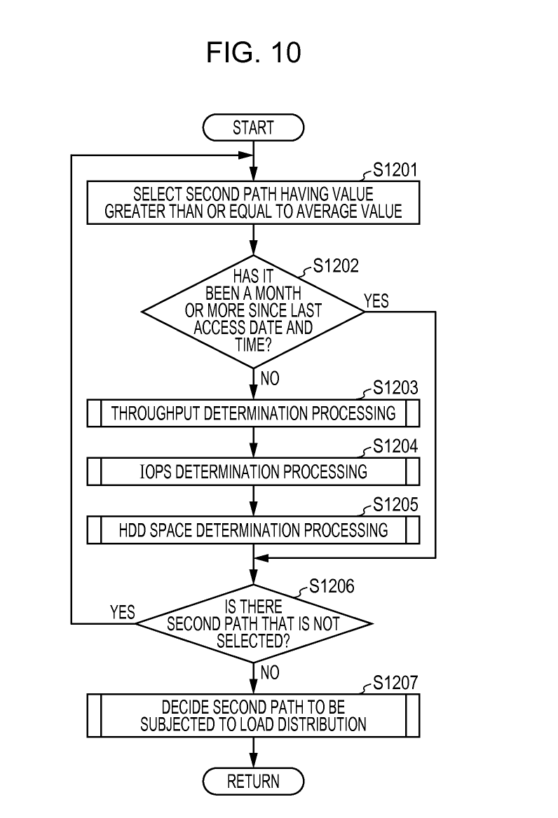

If it has not been a month or more since the last access date and time (step S1202: NO), the storage control device #1 or the like performs throughput determination processing (step S1203). A specific processing procedure of the throughput determination processing will be described later with FIG. 11.

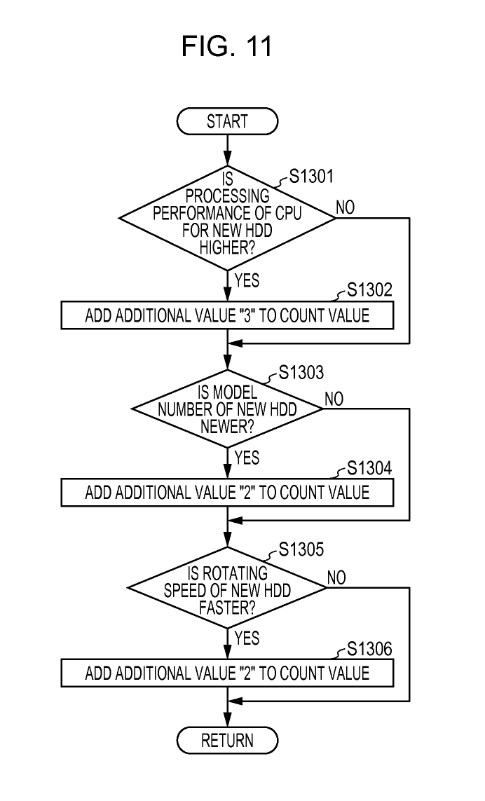

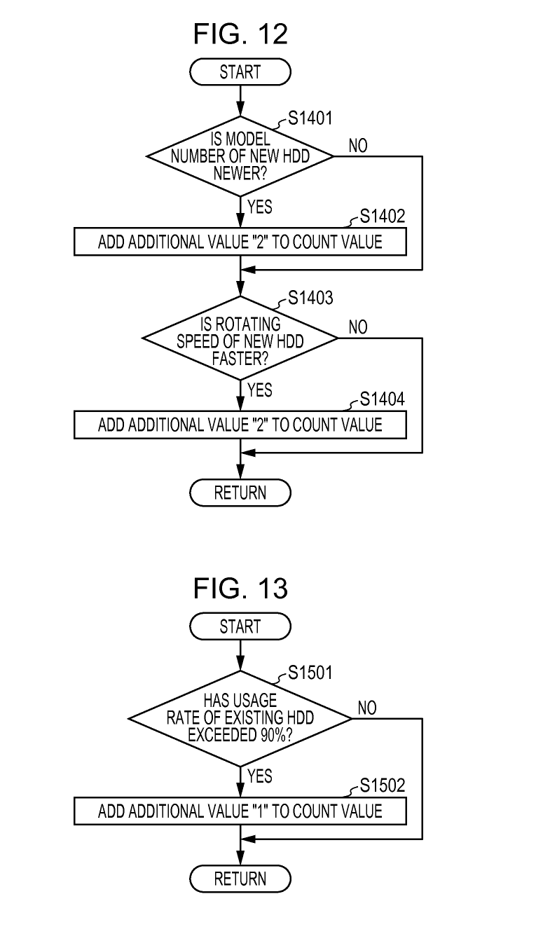

Next, the storage control device #1 or the like performs IOPS determination processing (step S1204). A specific processing procedure of the IOPS determination processing will be described later with FIG. 12. Next, the storage control device #1 or the like performs HDD space determination processing (step S1205). A specific processing procedure of the HDD space determination processing will be described later with FIG. 13.

Then, the storage control device #1 or the like determines whether there is a second path that is not selected and has throughput and IOPS of values greater than or equal to the average values (step S1206). If there is a second path that is not selected (step S1206: YES), the storage control device #1 or the like returns to step S1201.

If there is no second path that is not selected (step S1206: NO), the storage control device #1 or the like refers to the count value in the path management information 400 and determines a second path to be subjected to load distribution (step S1207) and returns to the step in which the processing for deciding the second path to be subjected to load distribution is called.

Specifically, for example, the storage control device #1 or the like may decide a second path which has the largest count value as a second path to be subjected to load distribution. Moreover, for example, the storage control device #1 or the like may decide a predetermined number of second paths in descending order of the count values as second paths to be subjected to load distribution.

Accordingly, it is possible to extract a second path for which an increase in I/O access performance may be expected as a second path to be subjected to load distribution.

<Throughput Determination Processing Procedure>

The specific processing procedure of the throughput determination processing in step S1203 illustrated in FIG. 10 will next be described. Because the throughput is an amount of data input and output per unit time, it is considered that the processing performance of the CPU, the model number of the HDD to which connection is established, and the rotating speed of the HDD to which connection is established are factors that affect the throughput.

FIG. 11 is a flowchart illustrating an example of the specific processing procedure of the throughput determination processing. In the flowchart in FIG. 11, the storage control device #1 or the like first determines whether the performance of the CPU in the same cabinet as the new HDD is higher than the performance of the CPU in the same cabinet as the existing HDD for the second path selected in step S1201 illustrated in FIG. 10 (step S1301).

If the performance of the CPU in the same cabinet as the new HDD is lower or the processing performance of the CPUs is the same (step S1301: NO), the storage control device #1 or the like shifts to step S1303.

If the performance of the CPU in the same cabinet as the new HDD is higher (step S1301: YES), the storage control device #1 or the like adds an additional value “3” to the count value in the path management information 400 corresponding to the selected second path (step S1302). The additional value “3” corresponds to Count (additional value) for the CPU processing performance included in the performance information D for the second paths.

Next, the storage control device #1 or the like determines whether the model number of the new HDD is newer than the model number of the existing HDD for the selected second path (step S1303). If the model number of the new HDD is older or the model numbers are the same (step S1303: NO), the storage control device #1 or the like shifts to step S1305.

If the model number of the new HDD is newer (step S1303: YES), the storage control device #1 or the like adds an additional value “2” to the count value in the path management information 400 corresponding to the selected second path (step S1304). The additional value “2” corresponds to Count (additional value) for the HDD model number included in the performance information D for the second paths.

Next, the storage control device #1 or the like determines whether the rotating speed of the new HDD is faster than the rotating speed of the existing HDD for the selected second path (step S1305). If the rotating speed of the new HDD is slower or the rotating speeds are the same (step S1305: NO), the storage control device #1 or the like returns to the step in which the throughput determination processing is called.

If the rotating speed of the new HDD is faster (step S1305: YES), the storage control device #1 or the like adds an additional value “2” to the count value in the path management information 400 corresponding to the selected second path (step S1306) and returns to the step in which the throughput determination processing is called. The additional value “2” corresponds to Count (additional value) for the rotating speed of the HDD included in the performance information D for the second paths.

<IOPS Determination Processing Procedure>

The specific processing procedure of the IOPS determination processing in step S1204 illustrated in FIG. 10 will next be described. Because the IOPS is the number of I/O accesses processed per second by the disk, it is considered that the model number of the HDD to which connection is established and the rotating speed of the HDD to which connection is established are factors that affect the IOPS.

FIG. 12 is a flowchart illustrating an example of the specific processing procedure of the IOPS determination processing. In the flowchart in FIG. 12, the storage control device #1 or the like determines whether the model number of the new HDD is newer than the model number of the existing HDD for the second path selected in step S1201 illustrated in FIG. 10 (step S1401).

If the model number of the new HDD is older or the model numbers are the same (step S1401: NO), the storage control device #1 or the like shifts to step S1403. If the model number of the new HDD is newer (step S1401: YES), the storage control device #1 or the like adds an additional value “2” to the count value in the path management information 400 corresponding to the selected second path (step S1402).

Next, the storage control device #1 or the like determines whether the rotating speed of the new HDD is faster than the rotating speed of the existing HDD for the selected second path (step S1403). If the rotating speed of the new HDD is slower or the rotating speeds are the same (step S1403: NO), the storage control device #1 or the like returns to the step in which the IOPS determination processing is called.

If the rotating speed of the new HDD is faster (step S1403: YES), the storage control device #1 or the like adds an additional value “2” to the count value in the path management information 400 corresponding to the selected second path (step S1404) and returns to the step in which the IOPS determination processing is called.

<HDD Space Determination Processing Procedure>

The specific processing procedure of the HDD space determination processing in step S1205 illustrated in FIG. 10 will next be described.

FIG. 13 is a flowchart illustrating an example of the specific processing procedure of the HDD space determination processing. In the flowchart in FIG. 13, the storage control device #1 or the like first determines whether the usage rate of the existing HDD for the second path selected in step S1201 illustrated in FIG. 10 has exceeded 90% (step S1501).

If the usage rate of the existing HDD is lower than or equal to 90% (step S1501: NO), the storage control device #1 or the like returns to the step in which the HDD space determination processing is called.

If the usage rate of the existing HDD has exceeded 90% (step S1501: YES), the storage control device #1 or the like adds an additional value “1” to the count value in the path management information 400 corresponding to the selected second path (step S1502) and returns to the step in which the HDD space determination processing is called. The additional value “1” corresponds to Count (additional value) for the HDD free space included in the performance information D for the second paths.

In the above description, among the second paths in the storage system 100, the count values are calculated for the second path which has the throughput and IOPS of values greater than or equal to the average values and of which it has not been a month or more since the last access date and time, but this is not a limitation. For example, the throughput, IOPS, and last access date and time may be in addition format, and among the second paths in the storage system 100, a second path which has the largest count values may be decided as a second path to be subjected to load distribution.

(First Path Control Processing Procedure by the Storage Control Device #1 or the Like)

An example of a first path control processing procedure by the storage control device #1 or the like will next be described. First path control processing is performed by the path driver for the first path of the storage control device #1 or the like in response to, for example, an I/O access from the host server 103.

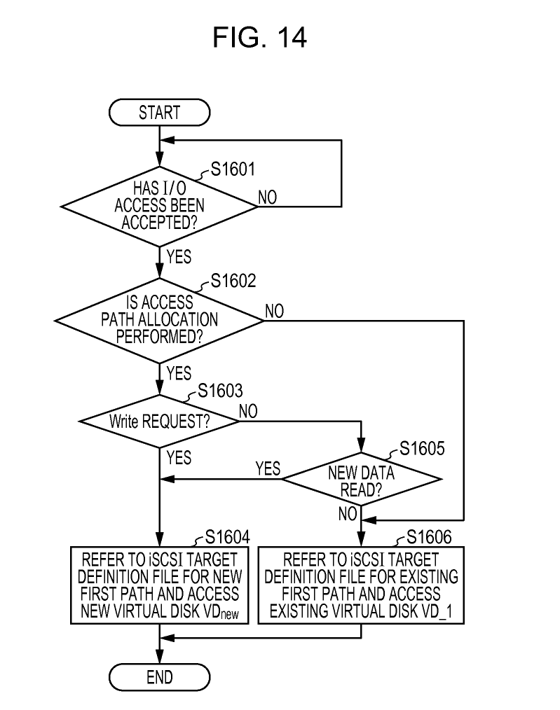

FIG. 14 is a flowchart illustrating the example of the first path control processing procedure by the storage control device #1 or the like. In the flowchart in FIG. 14, the storage control device #1 or the like first determines whether an I/O access has been accepted (step S1601). The storage control device #1 or the like waits until an I/O access is accepted (step S1601: NO).

When the I/O access has been accepted (step S1601: YES), the storage control device #1 or the like refers to the iSCSI frame information and determines whether to perform access path allocation (step S1602). If access path allocation is not performed (step S1602: NO), the storage control device #1 or the like shifts to step S1606.

If access path allocation is performed (step S1602: YES), the storage control device #1 or the like determines whether the request is a Write request (step S1603). If the request is a Write request (step S1603: YES), the storage control device #1 or the like refers to the iSCSI target definition file for the new first path and accesses the new virtual disk VD_{new} (step S1604) and ends a sequence of the processing in this flowchart.

If the request is a Read request (step S1603: NO), the storage control device #1 or the like refers to the differential bitmap and determines whether new data is read (step S1605). If new data is read (step S1605: YES), the storage control device #1 or the like shifts to step S1604.

If existing data is read (step S1605: NO), the storage control device #1 or the like refers to the iSCSI target definition file for the existing first path and accesses the existing virtual disk VD_{—}1 (step S1606) and ends a sequence of the processing in this flowchart.

Accordingly, it is possible to distribute an I/O access load on the first path to be subjected to load distribution.

(Second Path Control Processing Procedure by the Storage Control Device #1 or the Like)

An example of a second path control processing procedure by the storage control device #1 or the like will next be described. Second path control processing is performed by the path driver for the second path of the storage control device #1 or the like in response to, for example, an I/O access from the path driver for the first path.

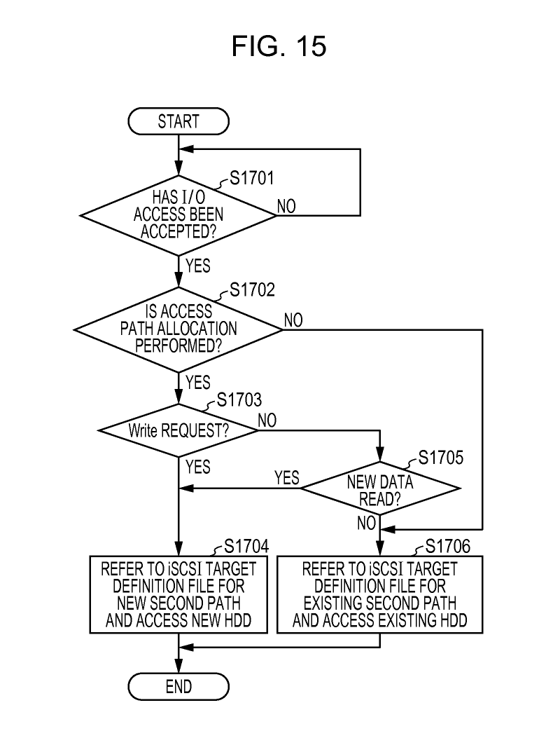

FIG. 15 is a flowchart illustrating the example of the second path control processing procedure by the storage control device #1 or the like. In the flowchart in FIG. 15, the storage control device #1 or the like first determines whether an I/O access has been accepted (step S1701). The storage control device #1 or the like waits until an I/O access is accepted (step S1701: NO).

When the I/O access has been accepted (step S1701: YES), the storage control device #1 or the like refers to the iSCSI frame information and determines whether to perform access path allocation (step S1702). If access path allocation is not performed (step S1702: NO), the storage control device #1 or the like shifts to step S1706.

If access path allocation is performed (step S1702: YES), the storage control device #1 or the like determines whether the request is a Write request (step S1703). If the request is a Write request (step S1703: YES), the storage control device #1 or the like refers to the iSCSI target definition file for the new second path and accesses the new HDD (step S1704) and ends a sequence of the processing in this flowchart.

If the request is a Read request (step S1703: NO), the storage control device #1 or the like refers to the differential bitmap and determines whether new data is read (step S1705). If new data is read (step S1705: YES), the storage control device #1 or the like shifts to step S1704.

If existing data is read (step S1705: NO), the storage control device #1 or the like refers to the iSCSI target definition file for the existing second path and accesses the existing HDD (step S1706) and ends a sequence of the processing in this flowchart.

Accordingly, it is possible to distribute an I/O access load on the second path to be subjected to load distribution.

As described above, in response to acceptance of the addition instruction, the storage control device #1 or the like may refer to the performance information D for the first paths and extract a first path to be subjected to I/O access load distribution. Accordingly, in response to scale-out of the storage system 100, it is possible to extract a bottleneck first path.

The storage control device #1 or the like may also refer to the performance information D for the first paths and extract, among the first paths in the storage system 100, a path which has response time of a value greater than or equal to an average value as a first path to be subjected to load distribution. Accordingly, it is possible to extract a first path in which time from the issue of a processing request to the start of output of a processing result is relatively slow as a first path to be subjected to load distribution.

The storage control device #1 or the like may also extract a first path to be subjected to load distribution based on the last access date and time of the first path. Accordingly, it is possible to exclude, from paths to be subjected to load distribution, a first path for which an access frequency has become low and which is no longer used currently.

The storage control device #1 or the like may also set a new first path connecting the new virtual disk VD_{new} that has the same space as the existing virtual disk VD_{—}1 to which a first path to be subjected to load distribution is connected and the host server 103. The storage control device #1 or the like may also set a new second path connecting the new virtual disk VD_{new} and the added HDD. Accordingly, it is possible to add the new first path for distributing an I/O access load on the first path to be subjected to load distribution.

The storage control device #1 or the like may also perform control so that the first path to be subjected to load distribution is used to read existing data and the new first path is used to write and read new data. Accordingly, it is possible to distribute an I/O access load on the first path to be subjected to load distribution, and increase I/O access performance of the storage system 100 without migrating data between the base shelf and the expansion shelf.

The storage control device #1 or the like may also refer to the performance information D for the second paths and extract a second path to be subjected to I/O access load distribution. Accordingly, during operation of the storage system 100, at a time point specified in advance, it is possible to extract a bottleneck second path.

The storage control device #1 or the like may also refer to the performance information D for the second paths and extract, among the second paths in the storage system 100, a path which has at least throughput or IOPS of a value greater than or equal to an average value as a second path to be subjected to load distribution. Accordingly, it is possible to extract a second path on which an I/O access load is relatively high as a second path to be subjected to load distribution.

The storage control device #1 or the like may also extract a second path to be subjected to load distribution based on the last access date and time of the second path. Accordingly, it is possible to exclude, from paths to be subjected to load distribution, a second path for which an access frequency has become low and which is no longer used currently.

The storage control device #1 or the like may also extract a second path to be subjected to load distribution, based on processing performance of a CPU in the same cabinet as the existing HDD for each second path and processing performance of a CPU in the same cabinet as the new HDD. Accordingly, it is possible to extract a second path for which an increase in I/O access performance may be expected by adding an access path from the existing virtual disk VD_{—}2 to the new HDD, as a second path to be subjected to load distribution.

The storage control device #1 or the like may also extract a second path to be subjected to load distribution, based on the model number of the existing HDD for each second path and the model number of the new HDD. Accordingly, it is possible to extract a second path for which an increase in I/O access performance may be expected by adding an access path from the existing virtual disk VD_{—}2 to the new HDD, as a second path to be subjected to load distribution.

The storage control device #1 or the like may also extract a second path to be subjected to load distribution, based on the rotating speed of the existing HDD for each second path and the rotating speed of the new HDD. Accordingly, it is possible to extract a second path for which an increase in I/O access performance may be expected by adding an access path from the existing virtual disk VD_{—}2 to the new HDD, as a second path to be subjected to load distribution.

The storage control device #1 or the like may also extract a second path to be subjected to load distribution, based on the free space of the existing HDD for each second path. Accordingly, it is possible to keep the usage rate of the HDD from exceeding an upper limit and to attempt to level the usage rates of the HDDs in the storage system 100.

The storage control device #1 or the like may also identify any of the HDDs in the storage system 100 as a new HDD based on the free spaces of the HDDs in the storage system 100. Accordingly, during operation of the storage system 100, at a time point specified in advance, it is possible to identify an HDD having a large space as an HDD to which the second path is connected.

The storage control device #1 or the like may also set a new second path connecting the virtual disk VD_{—}2 to which the second path to be subjected to load distribution is connected and the new HDD. Accordingly, it is possible to add the new second path for distributing an I/O access load on the second path to be subjected to load distribution.

The storage control device #1 or the like may also perform control so that the second path to be subjected to load distribution is used to read existing data and the new second path is used to write and read new data. Accordingly, it is possible to distribute an I/O access load on the second path to be subjected to load distribution, and increase I/O access performance of the storage system 100 without migrating data between the base shelf and the expansion shelf.

Thus, in a scale-out type storage system, the storage control device and the control program according to the present embodiment may easily add a storage space without stopping the system, and achieve an early increase in performance during expansion. Also during operation, the storage control device and the control program according to the present embodiment may achieve an effective increase in performance, even if the user does not understand the system specifications and system states.

The control method described in the present embodiment may be implemented by executing a prepared program on a computer such as a personal computer or a workstation. The control program is recorded in a computer-readable recording medium such as a hard disk, a flexible disk, a CD-ROM, an MO, or a DVD, and read from the recording medium and executed by the computer. The control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a memory that stores performance information for first paths that connect virtual disks in a storage system to a higher-level device and performance information for second paths that connect memory devices in the storage system to the virtual disks; and
a processor configured to:
extract a first path to be subjected to load distribution of I/O access from among the first paths in response to scale-out of the storage system by referring to the performance information for the first paths,
set a new first path that connects a new virtual disk to the higher-level device, the new virtual disk having the same space as a virtual disk to which the first path to be subjected to load distribution is connected,
set a new second path that connects the new virtual disk to an added memory device,
use the first path to be subjected to load distribution to read existing data stored in the virtual disk that is connected to the first path to be subjected to load distribution, and
use the new first path to write and read new data to be written to the new virtual disk as differential data to the existing data.

2. The storage control device according to claim 1, wherein
the processor:
identifies a memory device, among the memory devices in the storage system, based on free space of each memory device in the storage system,
extracts a second path to be subjected to load distribution of I/O access from among the second paths by referring to the performance information for the second paths,
sets a new second path that connects the identified memory device to a virtual disk to which the second path to be subjected to load distribution is connected, and
uses the second path to be subjected to load distribution to read existing data stored in a memory device that is connected to the second path to be subjected to load distribution, and
uses the new second path to write and read new data to be written to the identified memory device as differential data to the existing data.

3. The storage control device according to claim 2, wherein
the processor refers to the performance information for the first paths and extracts a first path, from among the first paths, which has response time of a value greater than or equal to an average value as the first path to be subjected to load distribution,

4. The storage control device according to claim 3, wherein the processor extracts the first path to be subjected to load distribution based on a last access date and time of each first path.

5. The storage control device according to claim 2, wherein the processor refers to the performance information for the second paths and extracts a second path, from among the second paths, which has at least throughput or IOPS of a value greater than or equal to an average value as the second path to be subjected to load distribution.

6. The storage control device according to claim 5, wherein the processor extracts the second path to be subjected to load distribution based on a last access date and time of each second path.

7. The storage control device according to claim 5,
wherein the storage system includes a plurality of cabinets, each cabinet encloses a memory device and a storage control device including a processor,
wherein the processor extracts the second path to be subjected to load distribution, based on processing performance of a processor in the same cabinet as a memory device to which each second path is connected and processing performance of a processor in the same cabinet as the identified memory device.

8. The storage control device according to claim 5, wherein the processor extracts the second path to be subjected to load distribution, based on a model number of a memory device to which each second path is connected and a model number of the identified memory device.

9. The storage control device according to claim 5, wherein the processor extracts the second path to be subjected to load distribution, based on a rotating speed of a memory device to which each second path is connected and a rotating speed of the identified memory device.

10. The storage control device according to claim 5, wherein the processor extracts the second path to be subjected to load distribution based on free space of a memory device to which each second path is connected.

11. A storage control method comprising:
storing, into a memory, performance information for first paths that connect virtual disks in a storage system to a higher-level device and performance information for second paths that connect memory devices in the storage system to the virtual disks;
extracting a first path to be subjected to load distribution of I/O access from among the first paths in response to scale-out of the storage system by referring to the performance information for the first paths,
setting a new first path that connects a new virtual disk to the higher-level device, the new virtual disk having the same space as a virtual disk to which the first path to be subjected to load distribution is connected,
setting a new second path that connects the new virtual disk to an added memory device,
using the first path to be subjected to load distribution to read existing data stored in the virtual disk that is connected to the first path to be subjected to load distribution, and
using the new first path to write and read new data to be written to the new virtual disk as differential data to the existing data.
